(19) United States
(12) Patent Application Publication
(10) Pub. No.: US 2015/0320210 A1
(43) Pub. Date: Nov. 12, 2015

(54) Methods for Manufacturing a Drawer

(71) Applicant: Unilin, BVBA, Wielsbeke (BE)

(72) Inventor: Pieter DEVOS, Koolskamp (BE)

(73) Assignee: UNILIN, BVBA, Wielsbeke (BE)

(21) Appl. No.: 14/378,378

(22) PCT Filed: Feb. 5, 2013
(86) PCT No.: PCT/IB13/50948

§ 371 Date: Aug. 13, 2014

Related U.S. Application Data
(60) Provisional application No. 61/597,992, filed on Feb. 13, 2012.

(51) Int. Cl. A47B 88/00; B27F 4/00; B27F 1/08

(52) U.S. Cl. CPC A47B 88/0014; B27F 1/08; B27F 4/00

(57) ABSTRACT

A method for manufacturing drawers, wherein the drawers comprise walls as well as a bottom, and at least a first and a second of the walls comprise a tongue and a groove with locking parts. The respective groove is provided on the inner side of the first wall, whereas the respective tongue is provided on the distal end of the second wall. The first wall and second wall are manufactured of respectively one board.

This invention relates to methods for manufacturing drawers, as well as to drawers or drawer constructions which are obtained by means of such method.

It is known that drawers mostly are composed of a plurality of components or walls, such as, for example, a front wall, a rear wall, sidewalls and a bottom. Such drawers, or certain parts thereof, are often produced in large quantities by specialized companies, which then distribute these drawers or partial products of drawers to furniture maker. Thus, it is also clear that small optimizations in the production and assembly of such drawers can result in considerable economic advantages.

In WO 2010/070472, it has already been proposed to couple the walls of a drawer to each other by means of mutually engageable profiles, such that the use of separate connection elements and the costs associated therewith are excluded or restricted. The mutually engageable profiles are provided in the walls concerned by means of a milling process. Such milling process can be very expensive.

The present invention now relates to methods for manufacturing drawers, as well as well-defined combinations for composing drawers, which allow realizing further optimizations in the production, assembly, respectively, of drawers, which optimizations are of economic and/or technical nature, for example, either by enabling a smoother production or by guaranteeing a more stable construction.

To this aim, the invention relates to a method for manufacturing drawers, wherein the drawers comprise walls and a bottom, wherein said walls include at least a front wall, rear wall and two sidewalls, and wherein at least a first and a second of said walls comprise profiles which fit into each other in a locking manner and which to this aim make use of a tongue and a groove with locking parts, wherein said profiles can be joined into each other laterally, and wherein the respective groove is provided on the inner side of the first wall, whereas the respective tongue is provided on the distal end of the second wall, characterized in that two or more walls are manufactured of one board; that herein the profiles of at least two of the respective walls are formed by means of a treatment, whether or not consisting of a plurality of partial treatments, performed on said board; and that said board is divided into two or more walls only after at least parts of said profiles have been formed. Such method allows a far-reaching economization in the production process of drawers with locking profiles.

Preferably, said treatment is a continuous treatment, wherein the respective board is transported, for example, along one or more, whether or not rotating, cutting tools, wherein said cutting tools engage on the distal ends and/or on the surface of the board in order to form said profiles or parts thereof. Preferably, said transport is performed in the direction or approximately in the direction of the final distal ends.

According to a first possibility, the final two walls concerned extend in said board each time with a distal end of one of the walls directed towards the distal end of another wall. Dividing the board then preferably is realized at least by performing a cut situated between the directed towards each other distal ends and preferably parallel or almost parallel to the distal ends. In such case, said board preferably is transported along the tools or cutting tools according to the direction of these distal ends.

According to a second possibility, the final two walls concerned extend in said board each time with their distal end in each other's prolongation, or at least with their distal ends parallel to each other. Dividing the board then preferably is performed at least by performing a cut situated transverse to the respective parallel distal ends. In such case, said board preferably is transported along the tools or cutting tools according to the direction of these distal ends.

Preferably, said profiles comprise at least a tongue, for example, said tongue of the second wall, which preferably is formed on a distal end of said board. It is not excluded that said tongue might be formed centrally in said board, at the location of a final distal end of a wall, said distal end being obtained after dividing the board. According to a particular embodiment, such tongue can substantially be obtained by means of cutting treatments which engage on only one flat side of said board.

Preferably, said profiles comprise at least a groove, for example, said groove of the first wall, which preferably is formed in a flat side of said board.

Preferably, at least said first wall and second wall are formed of said one board. Preferably, in such case said board is divided into the first wall and the second wall after at least portions of said profiles have been formed already, namely of said tongue and said groove, whether or not including the locking parts. Preferably, the contour of said tongue as well as of said groove, including the locking parts, has been formed already.

According to the most preferred embodiment, three walls, which preferably fit into each other in a locking manner, are obtained from said board, for example, two sidewalls and a front wall, or, according to another example, two sidewalls and a rear wall.

Preferably, all locking profiles of the respective walls are formed at least partially or even entirely prior to dividing said board into the three walls concerned.

It is possible that after dividing the respective board, one or more other treatments, such as edge treatments, are performed on one or more of the obtained walls. According to a first example, after said dividing also one or more treatments can be performed for realizing connection means other than locking profiles. Preferably, to this end also bores are made, for example, one or more bore treatments performed for providing dowels or other attachment elements or fittings. According to a second example, which either is or is not combined with said first example, after said dividing also one or more masking treatments can be performed, for example, by means of a laminate strip or an ABS strip.

Preferably, in an installation provided for this purpose, the board is transported by means of a continuous system from an input along at least one treatment station towards an output, wherein in the treatment station the profile of said groove is drawn by means of at least one milling cutter.

According to a particular embodiment of the invention, said treatment comprises at least a partial treatment, wherein a cutting tool is simultaneously active on both walls, which walls then still are part of said one board. Preferably, the cutting tool simultaneously forms parts of a groove and of a tongue. To this aim, the cutting tool preferably is arranged in an inclined manner in respect of the plane of the board. Preferably, hereby an angle of 5° to 60° is formed with the normal of this plane. Preferably, at least two and possibly exactly two cutting tools are applied for forming the respective groove as well as the respective tongue, such that two partial treatments suffice for forming both profiles or at least for forming an essential part of these profiles.

The invention further also relates to a device which is ideally suited for realizing the aforementioned method. This device has the characteristic that it consists of a continuous system and various treatment stations erected there along for performing one or more of the treatments described in the aforementioned method.

It is clear that the invention generally is applicable for manufacturing drawers, the walls of which are manufactured of wood-based material, such as particle board, MDF, HDF and the like and wherein the locking profiles are realized by means of machining cutting tools, for example, milling cutters.

The various walls can be coated, for example, with laminate or film. Also, provisions can be taken in order to obtain that in mounted condition, the ends of the profiles are hidden from view, for example, by means of masking strips, such as described in WO 2010/070472. As aforementioned, such masking strips can be provided after said board already has been divided into two or more of the respective walls.

It is noted that in general in relation to the invention, reference is made to walls of a drawer and that these walls may concern sidewalls, rear walls, front walls or front panels, or possibly even the back. It is not excluded that techniques which are specifically described with reference to one type of walls, for example, to the sidewalls, can also be applied to another type of walls, for example, to the front walls or front panels. Further, it is not excluded that the invention is applied with other furniture or furniture components than drawers. For example, this may relate to a composed element consisting of at least four walls and a bottom. Herein, this may relate, for example, to a cupboard having a bottom wall, an upper wall, two sidewalls and a back, wherein at least one of the walls is attached to two distal ends of adjoining walls by means of profiles obtained on the basis of the invention.

According to a first example, the drawer obtained by means of the method may have a composition with one or more of the following characteristics:
the locking profiles are laterally insertable, such by means of a turning and/or snapping movement;
the front wall consists of only one wall part, which then also forms the front part of the drawer;
the front wall is made as a front panel which with its rear side faces the end faces of the foremost ends of the sidewalls;
the rear wall is situated between the sidewalls, which means that the rear wall adjoins with its end face sides against the inner sides of the sidewalls;
the sidewalls are provided with openings and/or recesses for attaching fittings, more particularly for attaching thereto components of a fitting mechanism for slidably supporting the drawer.

According to a second example, the drawer obtained according to the invention as such combines at least the following characteristics:
the front wall is connected to the sidewalls by means of mutually cooperating locking profiles, more particularly profiles which fit into each other laterally, preferably by means of a turning movement;
the rear wall is connected to the sidewalls by means of connecting means other than locking profiles;
the drawer is movably supported by means of a fitting mechanism.

According to various preferred embodiments, the drawer construction of the second example further is characterized by any of the following possibilities:
that the rear wall is situated between the sidewalls and that the rear wall is connected to the sidewalls by means of coupling means which allow attaching the sidewalls laterally onto the distal ends of the rear wall, preferably by means of dowels or the like; that the fitting mechanism is of the type which provides for a support which offers positive lateral support;
that said fitting mechanism is attached to the drawer by means of fitting parts, which are attached to the sidewalls, more particularly laterally against these or underneath these.

According to a third example, the drawer obtained according to the invention as such combines at least the following characteristics:
the front wall is connected to the sidewalls by means of mutually cooperating locking profiles which fit into each other laterally, such by means of a turning movement,
wherein the sidewalls in respect to the drawer to be formed can be attached to the front wall by means of a turning movement from the inside towards the outside;
the rear wall is connected to the sidewalls by means of connecting means other than locking profiles.

According to a fourth example, the drawer obtained according to the invention as such combines at least the following characteristics:
the front wall is connected to the sidewalls by means of mutually cooperating locking profiles which fit into each other laterally, such preferably by means of a turning movement;
the rear wall is connected to the sidewalls by means of dowels or the like, which are inserted through the sidewalls up into the distal ends of the rear wall.

According to a fifth example, the drawer obtained according to the invention as such combines at least the following characteristics:
at least one of the walls, preferably the front wall, is attached with its inner side, on opposite sides, against the two distal ends of the two walls adjoining thereto, by means of locking profiles formed by grooves in the inner side and tongues on the distal ends;
the tongues and grooves are made such that such tongue can be slid into the pertaining groove without any turning or without any considerable turning of the respective wall by means of an inclined displacement, whereas inserting the tongue into the groove according to a displacement perpendicular to said inner side is impossible;
the whole of the drawer is configured such that, as soon as the whole is assembled, the inclined displacement is rendered impossible and it is prevented that it can shift apart again.

According to a sixth example, the drawer obtained according to the invention shows the following characteristics:
the front wall is connected to the sidewalls by means of mutually cooperating locking profiles which fit into each other laterally, such preferably by means of a turning movement or by means of a horizontal shifting or snap movement of the respective profiles towards each other; and
the rear wall is connected to the sidewalls by means of mutually cooperating locking profiles which fit into each other laterally, such preferably by means of a turning movement or by means of a horizontal shifting or snap movement of the respective profiles towards each other.

With the intention of better showing the characteristics according to the invention, herein below, as an example without any limitative character, some preferred embodiments are described, with reference to the accompanying drawings, wherein:

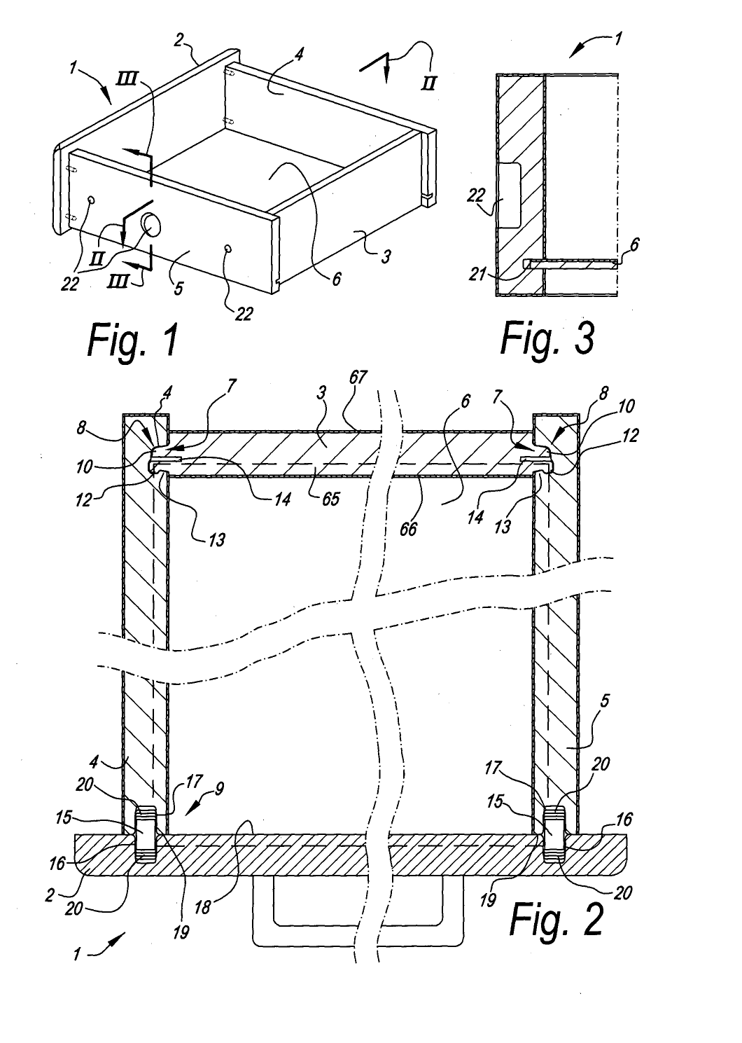

FIG. 1 in perspective represents a drawer manufactured by means of a method according to the invention;

FIGS. 2 and 3, at a larger scale, represent cross-sections according to lines II-II and III-III in FIG. 1;

FIG. 4 represents another drawer manufactured by means of a method according to the invention;

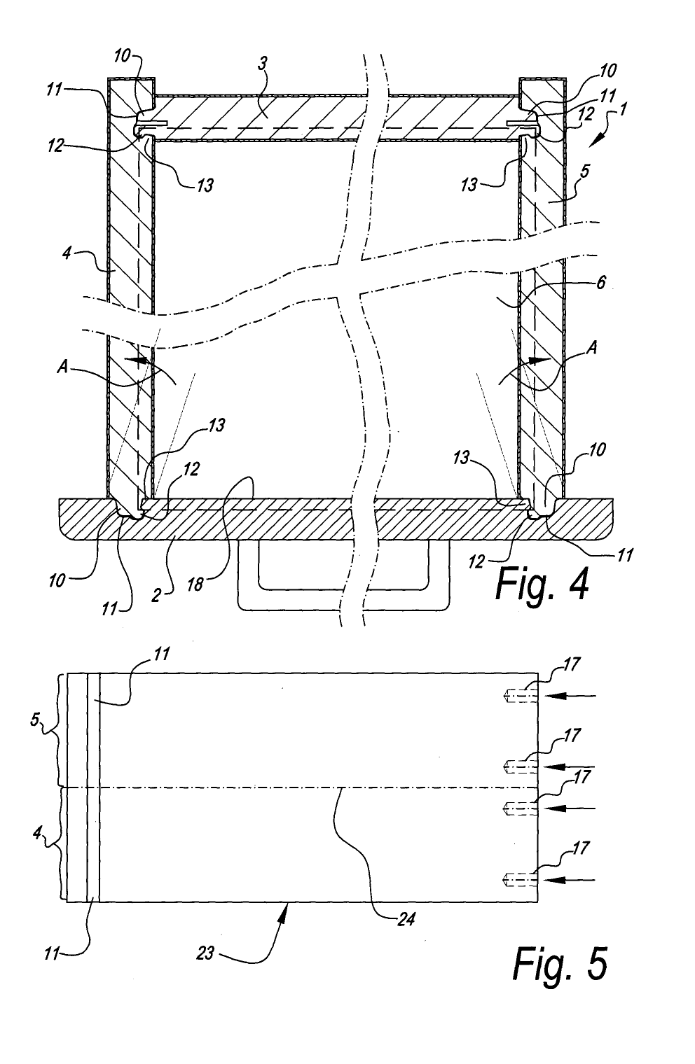

FIG. 5 schematically represents a step of a method according to the invention;

FIGS. 6 to 8 schematically illustrate how front panels or front walls can be manufactured, wherein these front walls can be applied in drawers obtained according to the method of the invention;

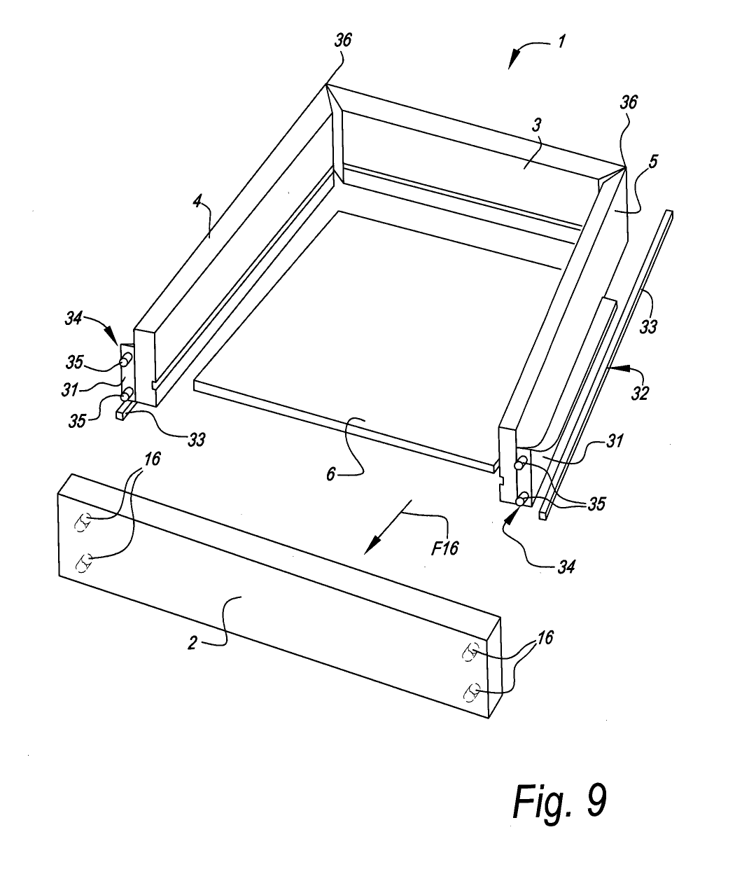

FIG. 9, schematically and in disassembled condition, shows another drawer according to a deviating variant;

FIG. 10, strongly schematized and in top plan view, represents another drawer obtained according to the invention;

FIG. 11 represents a variant of the portion indicated by F11 in FIG. 10;

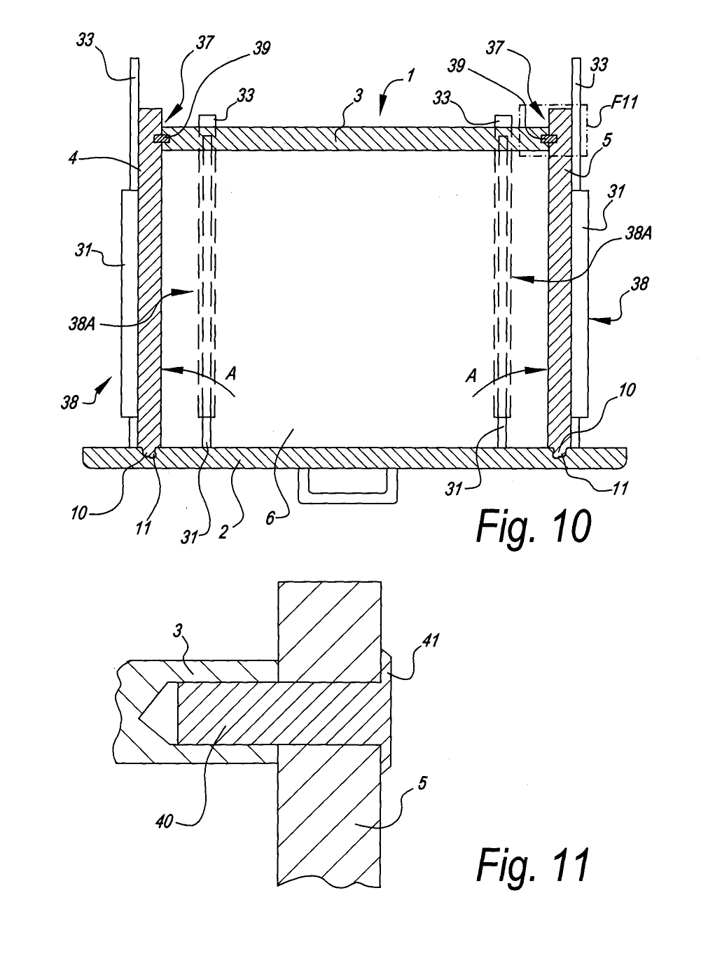

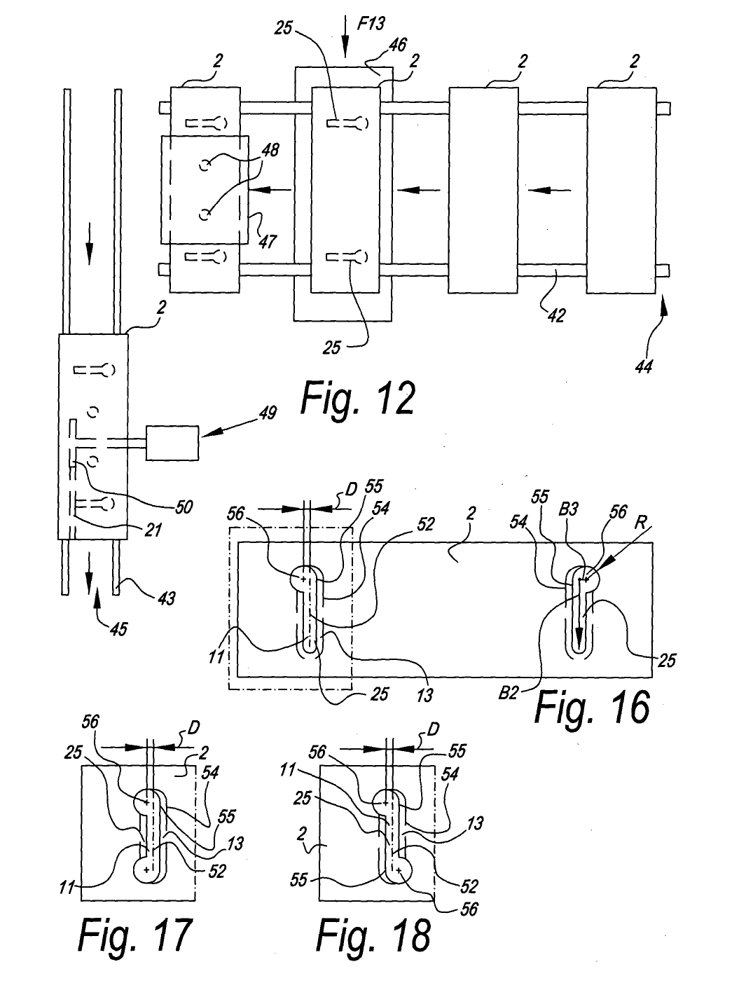

FIG. 12 in a top plan view represents a device for manufacturing the walls of FIGS. 6 to 8;

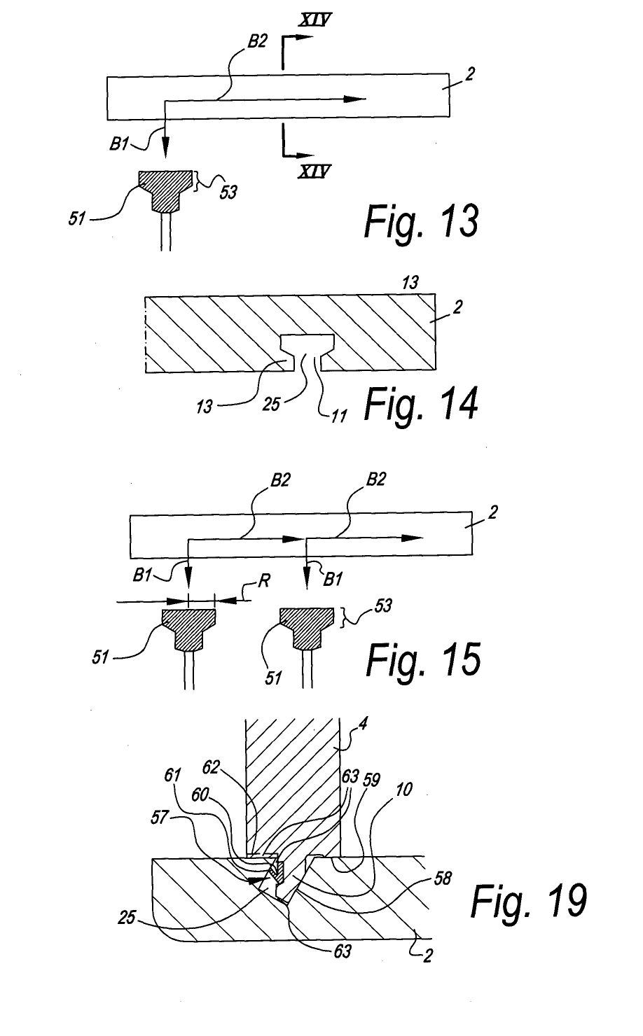

FIG. 13 schematically represents how a groove profile can be realized;

FIG. 14 represents a cross-section according to line XIV-XIV in FIG. 13;

FIG. 15 represents a variant of FIG. 13;

FIG. 16 represents groove profiles for variants, illustrated in a view according to the arrow F16 represented in FIG. 9, for a variant;

FIGS. 17 and 18, in a view onto the area indicated by F17 in FIG. 16, represent more variants of groove profiles;

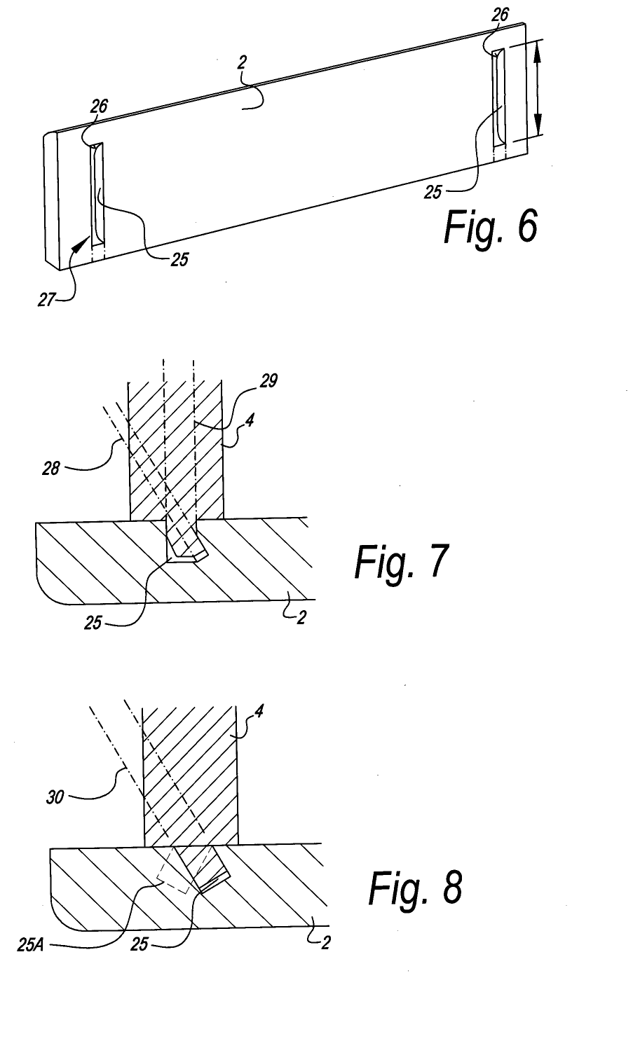

FIG. 19, in a view similar to that of FIG. 7, illustrates a particular embodiment of cooperating profiles;

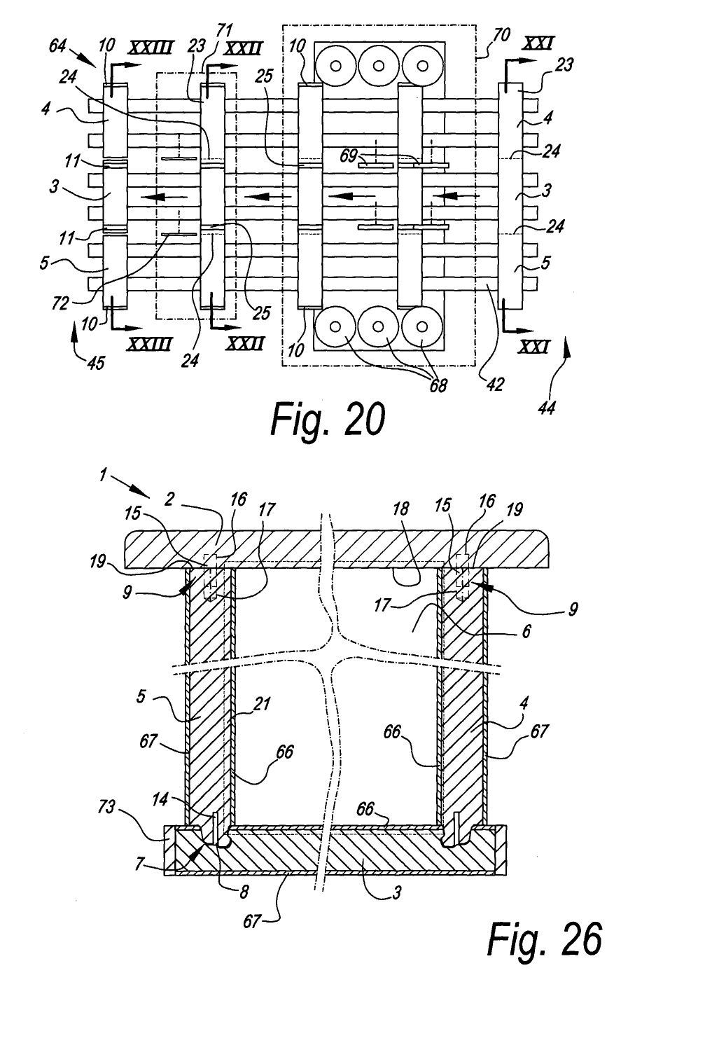

FIG. 20 represents a method for manufacturing drawers with the characteristics of the invention;

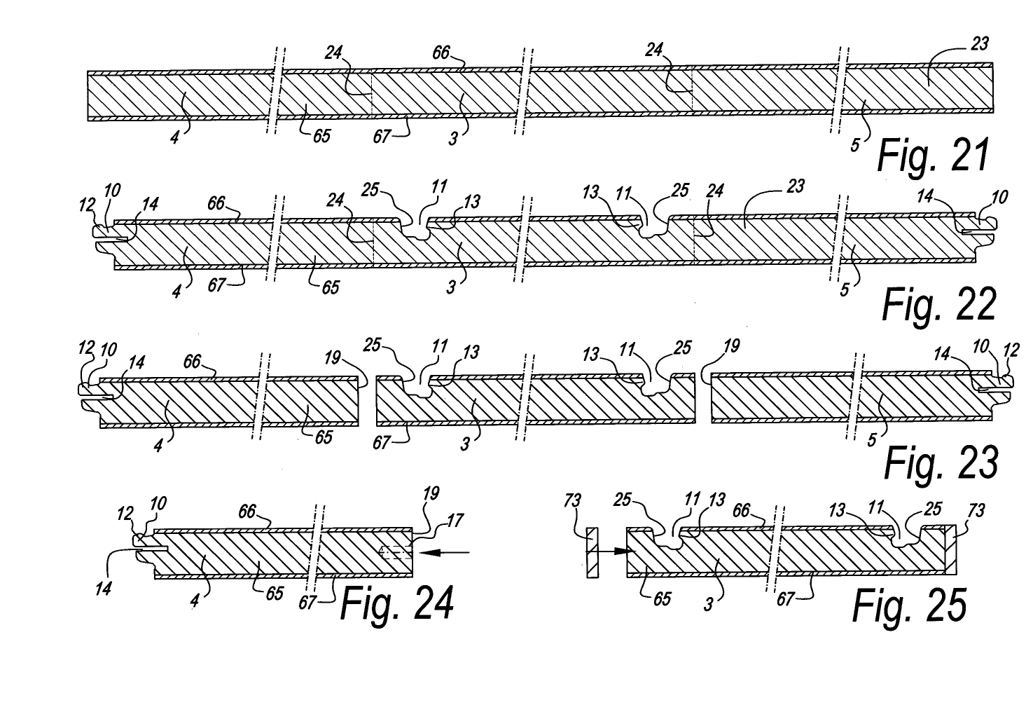

FIGS. 21 to 23 represent cross-sections according to the lines XXI-XXI XXII-XXII, XXIIII-XXIII indicated in FIG. 20;

FIGS. 24 and 25 represent possible post-treatments of the method of FIG. 20;

FIG. 26 represents a drawer which is obtained according to the method illustrated in FIG. 20;

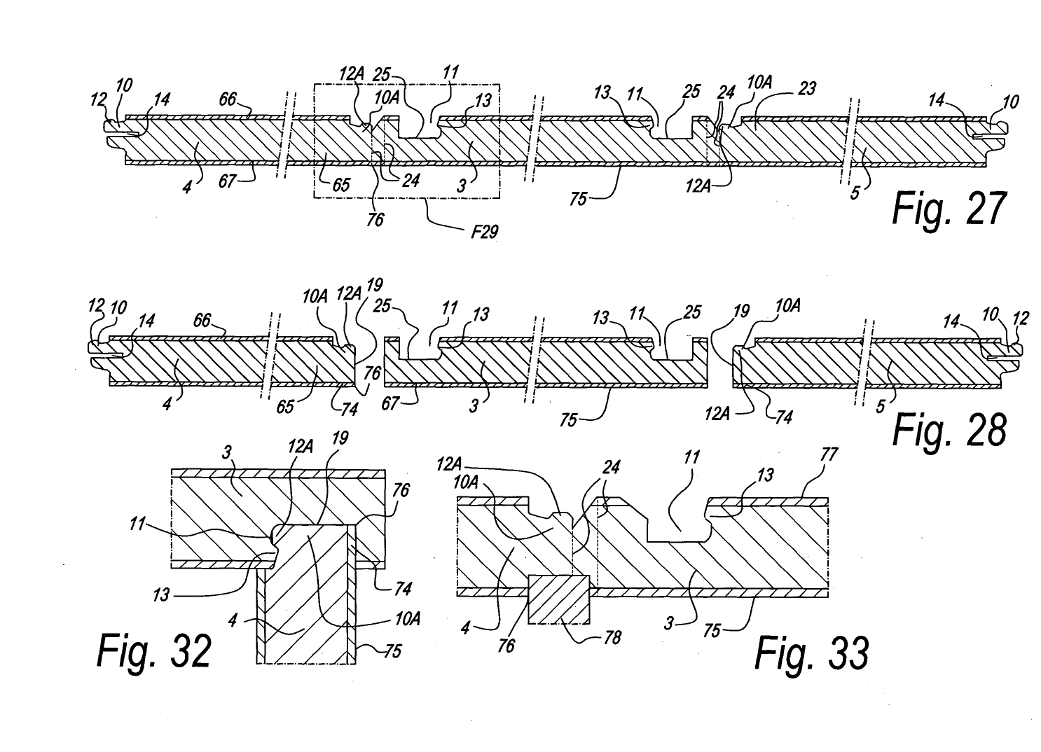

FIGS. 27 and 28, in a view similar to that of FIGS. 22 and 23, respectively represent a variant;

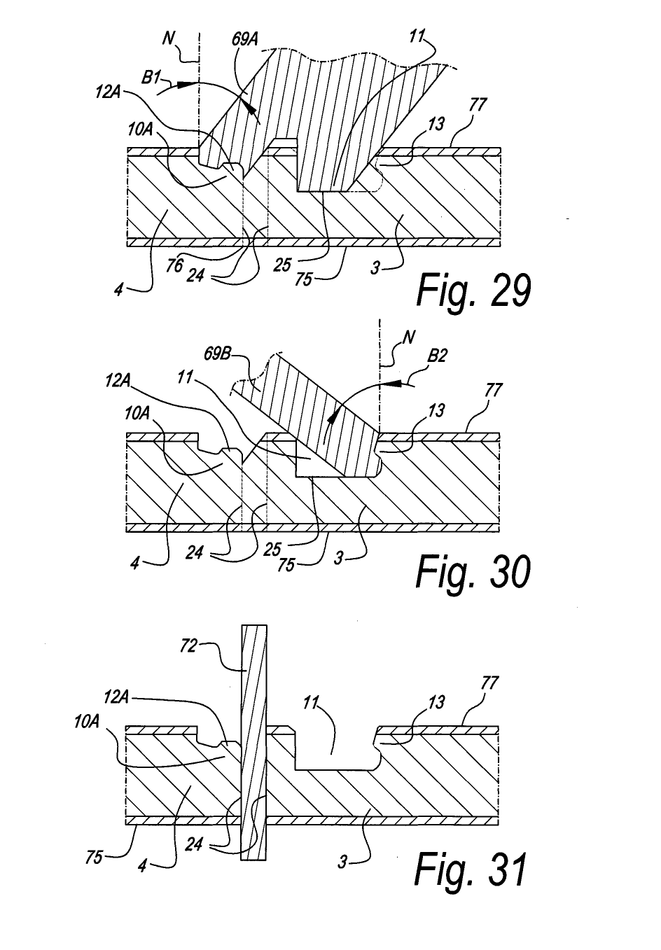

FIGS. 29 to 31, at a larger scale, in a view onto the area indicated by F29 in FIG. 27, illustrate how the profiles of FIGS. 27 and 28 can be realized;

FIG. 32, in a view similar to that of FIG. 11, represents how the profiles of FIGS. 27 to 31 fit into each other; and

FIG. 33, in a view similar to that of FIGS. 29-31, represents another variant.

In FIGS. 1 to 3, a drawer 1 is represented, which is manufactured in accordance with the method of the invention. Herein, the drawer 1 comprises at least a front wall 2, a rear wall 3 and two sidewalls 4-5, as well as a bottom 6.

The rear wall 3 is connected to the sidewalls 4-5 by means of mutually cooperating locking profiles 7-8, whereas the front wall 2 is connected to the sidewalls 4-5 by means of connection means 9 other than locking profiles.

In the represented example, the locking profiles 7-8 respectively consist of a tongue 10 and a groove 11, which are provided with respective locking parts 12-13, which, in the final position, prevent or at least counteract that the tongue 10 comes loose from the groove 11. In the represented example, the tongue 10 is split. Applying a gap 14 in the tongue 10 is particularly useful when the tongue 10 must be able to be pressed into the groove 11 by means of a snap movement, as this enhances the elasticity of the tongue. According to a not represented variant, use can also be made of solid tongues, thus, without the represented gap.

The profiles 7-8 in the represented example allow that the sidewalls 4-5 and the rear wall can be joined together by means of a turning movement as well as a snap movement.

In the represented example, the connection means 9 between the front wall 2 and the sidewalls 4-5 consist of separate connection elements 15, which work in conjunction with openings 16-17, more particularly bore holes, which are provided in the rear side 18 of the front wall 2 and the narrow side ends 19 of the sidewalls 4-5, respectively. In the example, these connection elements 15 are formed by dowels, more particularly mechanically locking dowels. In FIG. 2, to this aim dowels are applied having a corrugated, more particularly barb-shaped corrugated, surface 20.

Of course, other connection means can be applied as well.

As becomes clear from the figures, the drawer 1 can be designed such that the only locking profiles which are present thereon are those which are necessary for the connection between the rear wall 3 and the sidewalls 4-5, whereas for the remaining connections exclusively use is made of bore holes or other treatments which can be performed in a drilling line, in which then separate attachment elements can be provided, all this possibly completed by simpler profiles, such as grooves 21 for providing the bottom. Also, the following characteristics can be seen in the figures:
the locking profiles can be laterally inserted, by means of a turning and/or snap movement;
the front wall consists of only one wall part, which then also forms the front part of the drawer;
the front wall is made as a front panel, which is directed with its rear side towards the end face front ends of the sidewalls;
the rear wall is situated between the sidewalls;
the sidewalls are provided with openings and/or recesses 22 for attaching fittings, more particularly for attaching thereto components of a fitting mechanism for slidably supporting the drawer.

In FIG. 4, a drawer 1 is represented, which comprises a front wall 2, a rear wall 3 and two sidewalls 4-5, as well as a bottom 6. Further, both sidewalls 4-5 are connected to the front wall 2 as well as the rear wall 3 by means of profiles, which fit into each other in a locking manner and which make use of a tongue 10 and groove 11 with locking parts 12-13, wherein these profiles can be joined into each other laterally. The particularity consists in that the front wall 2 is directly attached to the sidewalls 4-5 and that the connection between the front wall 2 and the sidewalls 4-5 is realized in that the respective tongues 10 are provided distally on the foremost ends of the sidewalls 4-5, wherein these tongues 10 are realized as solid tongue profiles and thus not split, wherein the respective grooves 11 are located on the rear side of the front wall 2 and wherein the tongues 10 fit into the respective grooves by means of a turning movement A of the sidewalls. It is clear that in this manner a rigid locking can be realized between the front wall 2 and the sidewalls 4-5, as a result of which the front is attached to the remainder of the drawer 1 in a particularly stable manner.

In FIG. 5, a method according to the invention is illustrated. As already mentioned in the introduction, it relates to the manufacture of drawers, wherein the drawers 1 comprise at least a front wall 2, rear wall 3 and two sidewalls 4-5 as well as a bottom, and wherein at least two walls, in this case the two sidewalls 4-5 as well as the rear wall 3, comprise profiles which fit into each other in a locking manner and which for this purpose make use of a tongue 10 and groove 11 with locking parts 12-13, wherein these profiles can be joined into each other laterally. The groove 11 respectively is provided on the inner side of a sidewall. As FIG. 5 represents, the particularity of the method consists in that at least two walls, in this case the sidewalls 4-5, are made of respectively one board 23. In the example, the grooves 11 are realized by means of a continuous treatment, whether or not consisting of a plurality of partial treatments, such as milling operations; and only thereafter said board is divided into two or more sidewalls. Such dividing is performed according to the represented line 24, for example, by means of a saw operation, transverse to the profiles, or the groove 10. Such drawer can be realized by means of a continuous treatment, more particularly by means of the second possibility thereof mentioned in the introduction.

The two sidewalls 4-5 preferably are those which are intended to form part of one and the same drawer 1.

Further, openings 17, such as bore holes, can be provided in the board 23 before the latter is sawn, or beforehand, in order to realize connections with the front wall. Of course, other post-treatments are not excluded, either.

Thus, it is clear that the method is particularly suitable for realizing drawers, such as the one illustrated in FIG. 2.

FIGS. 6 to 8 illustrate how front panels or front walls can be manufactured, which are suitable in particular for fitting together in a locking manner with profiles formed on distal ends of sidewalls 4-5 of such drawer 1. As an example, in FIG. 6 a front of a drawer 1 is represented, with on the rear side two locking groove profiles 25, to which sidewalls 4-5 can be coupled, wherein the groove profiles 25 are not made continuous on at least one of their ends 26. Further, it is represented in solid line that such groove profile 25 can also be made not continuous on the other end 27, or, according to an alternative illustrated in dashed line, can be continuous indeed.

The particularity herein consists in that the groove profile 25 is realized by means of one or more cuts by means of one or more rotating cutting tools which engage in the surface from the outside, wherein the cutting tool and the respective panel-shaped element perform a through-feed displacement in the longitudinal direction of the cut, and, for forming said end, locally is moved in and/or out of the surface of the panel-shaped element.

The cuts are preferably realized by means of saws or saw cutters.

FIG. 7 represents an embodiment wherein the groove profile 25 is realized by means of two cuts 28-29. FIG. 8 represents a second embodiment, wherein the groove profile is realized by only one cut 30. By pressing the cutting tools applied therein locally into the panel-shaped elements and/or taking them out of those, then in a continuous manner and thus in an efficient manner locking groove profiles can be realized which are finite at least on one end.

In FIG. 9, an example of a deviating variant of a drawer 1 is represented, which further illustrates some aspects of the invention, however, which does not belong thereto. This drawer 1 comprises at least a front wall 2, more particularly a front panel, two sidewalls 4-5, as well as a bottom 6, with the particular characteristic that the drawer comprises a fitting component 31, which forms part of or directly cooperates with a guide mechanism or fitting mechanism 32 for sliding out the drawer, wherein said fitting component 31 is attached to a sidewall 4-5, on the one hand, and, on the other hand, also provides for a connection with the front wall 2, more particularly the front panel. It is clear that the fitting component hereby obtains an additional function, which results in a stable and advantageous assembly.

The guiding mechanism 32 is represented only schematically in the form of fitting components, namely, first fitting components 31, which are attached to the drawer, and second fitting components 33, which are fixedly attached to a piece of furniture. The portion present therebetween can be of any kind and, for schematization, is omitted in the figure. By way of example, the portion present therebetween can consist of a telescopic system, a roller support, etc.

The fitting components 31 can be attached to the drawer, in particular to the sidewalls 4-5, in any manner, either by screws or in any other manner. In the example, these fitting components are situated laterally against the sidewalls 4-5, however, it is clear that, according to a not-represented variant, they can also be mounted, for example, underneath the sides 4-5.

The attachment between the front wall 2 and the fitting components 31 can also be performed in any manner. In the represented example, the first fitting component 31 to this aim is provided with forward-directed protruding portions 35, onto which the front wall, more particularly the front panel, can be fixed in that the portions 35 work in conjunction with openings 16, for example, by means of clamping, glue, etc.

In the example, the sidewalls 4-5 are connected to the rear wall 3 by means of film hinges 36. However, other kinds of connections are not excluded herein. According to a not-represented embodiment, instead of film hinges use shall be made of coupling means which are formed by profiles which engage in each other, for example, as in FIG. 2. In such case, the drawer preferably is obtained by means of the method of the invention.

In FIG. 10, a number of possibilities of drawer constructions are represented in a schematic manner. Herein, this relates to a drawer construction with a drawer 1 comprising at least a front wall 2, rear wall 3 and two sidewalls 4-5, as well as a bottom 6, with the particularity that the drawer construction as such combines at least the following characteristics:
the front wall 2 is connected to the sidewalls 4-5 by means of mutually cooperating locking profiles, more particularly profiles which fit into each other laterally, preferably at least by means of a turning movement;
the rear wall 3 is connected to the sidewalls by means of connection means 37 other than locking profiles;
the drawer is movably supported by means of a fitting mechanism, more particularly guide mechanism 38.

In the example, the rear wall 3 is located between the sidewalls, and the rear wall 3 is connected to the sidewalls by means of coupling means which allow attaching the sidewalls laterally onto the distal ends of the rear wall, in this case by means of dowels 39.

The fitting components 31 are attached to the sidewalls 4-5 and movably supported in respect to the fitting components 33 which are intended for being fixedly attached to a piece of furniture.

As the fitting components 31 normally are positively supported laterally by the fixed fitting components 33, it is obtained that, once everything is assembled, at least a certain lateral support is given to the sidewalls 4-5, by which is prevented that the sidewalls 4-5 can move apart on the rearmost ends if the connection means 37 should not work correctly.

It is noted that the fitting components 31 do not necessarily have to be located against the sidewalls 4-5, but can also be mounted underneath the sidewalls.

According to a variant, a guide mechanism 38A is applied with fitting components 31-33 located underneath the drawer, and wherein, for example, the fitting components 33 are fixedly connected to the front wall 2 and the rear wall 3. In this manner, also an internal reinforcement is realized in the drawer, which, in combination with the particular assembly, results in a drawer which can be assembled in a smooth manner and still is clearly stable. FIG. 10 also illustrates that the sidewalls can be coupled to the front wall by means of a turning movement A from the inside towards the outside.

FIG. 11 represents the use of a dowel 40, which is inserted through the respective sidewall 5. In practice, the whole shall be made such that the dowel 40 clamps in the rear wall. In the sidewall it can be made clamping or not. In the case of a not-clamping cooperation between the dowel and the sidewall, a collar or head 41 will be provided.

It is noted that said FIG. 8 represents a particular example of a front panel. Herein, the groove or groove profile 25A, on the left as well as on the right hand side, is directed outward with its deepest point. This latter offers the advantage that in mounted condition at least the bottom prevents that the sidewalls will come loose from the front wall.

In FIG. 12, schematically an example is represented of a device for manufacturing front panels 2. The device comprises a continuous system with conveyor belts 42-43, which define an input 44 and output 45. The front walls 2 are provided with groove profiles 25 in a first treatment station 46, by means of milling cutters, which preferably engage on the front wall from below. In the treatment station 47, bore holes 48 are provided from above, for example, for providing handles. In the treatment station 49, by means of a saw 50 a groove 21 is provided in the downward-directed side for attaching the bottom. Herein, the front wall moves along the rotating saw. The saw possibly may move up and down when the groove does not have to be realized completely continuous. In the treatment stations, the work pieces preferably are lying still.

FIGS. 13 and 14 represent how a groove profile 25 can be realized by a milling cutter 51 with an entering movement B1 and a to- and fro-movement B2. FIG. 13 herein is a schematized view according to arrow F13 in FIG. 12.

FIG. 15 shows a variant, wherein an un-doubling is applied by making use of two milling cutters 51, in such a manner that two smaller movements B2 can be applied, which are performed simultaneously, which is time-saving.

It is clear that with such milling cutter, it is also possible to go in on one side and to go out again on the other. Possibly, this movement B2 can extend over two walls which still are connected as a single panel, wherein this panel afterwards is split in two. In such case, a method according to the invention is obtained.

FIG. 16 shows a groove profile 25 obtained by means of a variant, wherein an entering movement B1 is made by means of a milling cutter 51, at a distance from the line of movement B2 or the axis 52 of the actual groove profile 25. For bridging-over this distance D, the milling cutter 51, preferably after a widened part 53 of the milling cutter 51 is already situated below the surface of the wall 2 to be milled, and still better after this milling cutter 51 has reached its final depth, performs a lateral movement B3, preferably in the plane of the wall 2. Thereafter, the movement B1 is performed, possibly to and fro, as already described above. It is evident that in the exiting movement preferably the distance D is bridged-over again, in opposite direction of the original line of movement B3. The distance D in general preferably is smaller than the maximum radius R of the milling cutter 51. In this case, a distance D has been chosen which corresponds or approximately corresponds to the undercut to be performed. The lowermost contours of the obtained groove profile 25 are represented in dashed line 54.

The advantage of eccentric intrusion or performing the entering movement B1 with the center of the milling cutter at a distance D from the axis 52 of the groove profile 25 has the advantage that a higher quality cut can be obtained. In particular, the quality of the cut portion 55 increases next to the point 56, where the entering movement B1 or the exiting movement of the milling cutter 51 is performed. In general, the improved cut portion 55 preferably is situated on the edge of the groove profile 25 with which the locking part 12 of the tongue 10 cooperates, and/or on the inner side of the composed element or the drawer 1. Improving the quality of the cut is of particular interest for cutting in laminated panels, such as panels which are provided with a decorative layer, for example, of laminate, lacquer, melamine, PVC film, veneer and the like. Improving the quality of the cut is also of interest for milling in panels which substantially consist of particle board, such as wood particle board.

Another advantage of the eccentric intrusion is that a connection can be obtained over a larger part of the groove profile. The cut portion 55 now can also provide an undercut with which the locking part 12 of the tongue 10 can cooperate.

FIG. 17 represents an example, wherein the milling cutter 51 has entered on one side of the groove profile 25 and has exited on the other side, and wherein an eccentric entering/exiting is applied on both sides.

FIG. 18 represents another embodiment of an eccentric entering/exiting of the milling cutter 51, wherein the points 56 of entering and exiting can be found on opposite sides of the axis 52.

FIG. 19 represents another tongue and groove connection which can be applied within the scope of the invention, however, in general can be applied as a corner connection in any composed element. The particularity here is that the connection, in this case the tongue 10, is provided with a flexible material or with a flexible element 57. Such element 57 is provided for the annulation of any possible play in the tongue-groove connection. In a coupled condition, the flexible element 57 presses tongue portions, in this case the tongue portions made in one piece with the panel or sidewall 4, against reference surfaces 58-59 of the groove profile 25, by which an acceptable mutual positioning between the connected walls 2-4 can be created. Such connection can show less or no play in comparison with a traditional tongue and groove connection.

Preferably, a first reference surface 58 of said reference surfaces 58-59 is formed internally in the groove profile 25. Preferably, a second reference surface 59 of said reference surfaces 58-59 is formed on the surface of the wall 2 having the groove profile 52. Such arrangement of the reference surfaces is illustrated by means of FIG. 19. It is clear that the reference surfaces 58-59 generally preferably extend transverse in mutual respect.

The flexible element is here provided with a lip 61 which is rotatable around a hinge 60, which lip works in conjunction with the groove profile 25 for achieving said pressing-on. Of course, other mechanisms are not excluded. Preferably, a snap effect is applied, such as here, wherein during coupling of the walls 2-4 a to and fro movement of the flexible element 57 or a part thereof is created. It is also possible to apply elastic compression, followed by relaxation of a flexible material.

According to a variant, instead of working with a flexible element 57, also a whether or not rigid element can be applied, which, for example, as a wedge, is driven in an opening between the tongue and the groove, whether or not automatically, for achieving said pressing-on against the reference surfaces 58-59.

FIG. 19 represents in dashed line 62 that preferably a space 63 is applied between the surfaces of tongue and groove which do not form part of the reference surfaces 58-59.

Although illustrated here at the tongue 10, it is possible that the flexible element 57 or flexible material is located in the groove 11.

FIG. 20 schematically represents an example of a device 64 which applies the method of the invention. Herein, this relates specifically to an illustration of a continuous treatment according to the first possibility therefor mentioned in the introduction.

FIG. 21 represents that for manufacturing drawers 1 according to the invention it is started from a larger panel or board 23, from which at least two walls 3-4 are obtained. In this case, three walls 3-4-5, namely two sidewalls 3-5 and a rear wall 4, are obtained from the respective panel or board 23. The respective final walls 3-4-5 are located in each other's prolongation in the larger panel or the board 23, namely each time with a distal end of one wall directed to the distal end of another wall. In dashed line 24, the separation between the respective walls 3-4-5 is represented, as it will be obtained after dividing. The separation extends parallel to said distal ends. In this case, the larger panel or the board 23 has a core material 65, such as a MDF or HDF panel or a panel of wood particle board, with on both flat sides a decorative layer 66-67, such as, for example, a film or a laminate. Of course, the invention can also be applied for other types of panels, such as for solid wooden panels.

As FIGS. 20 and 22 represent, profiles are formed by means of milling tools 68-69, which profiles allow joining the finally obtained walls together in a locking manner. To this aim, use is made of a tongue 10 and groove 11 with locking parts 12-13, wherein these profiles can be joined together laterally and wherein the respective groove 11 is provided on the inner side of a first wall 3, namely in this case on the inner side of the final rear wall 3, whereas the respective tongue 10 is provided on the narrow side ends 19 of a second wall 4, namely in this case on one of the narrow side end 19 of both final sidewalls 4-5. For forming the tongue 10, the milling tools 68 engage on both short sides of the larger panel or the board 23; for forming the groove 11 or the groove profile 25, the milling tools 69, for example, as shown here, can engage on one of the flat sides of the larger panel or the board 23.

For forming the tongue 10, use is made of a continuous milling machine 70, wherein the larger panel or the board 23 is moved with its short edges over at least two and in this case three milling tools 68. It is known as such, for example, from WO 97/47834, to form locking profiles on the edge of a panel by means of at least two rotating milling tools. To this aim, preferably two rotating milling tools are applied, which are arranged at a different angle in respect to the panel.

For forming the groove 11 or the groove profile 25, the device 64 of FIG. 20 comprises at least two additional rotating milling tools 69 per groove 11 to be milled. In the example, these are arranged in the continuous milling machine 70.

FIGS. 20 to 22 clearly show that said rear wall 3 and both sidewalls 4-5 are made of one and the same board 23 and that herein the respective groove 11 and the respective tongue 10 are formed by means of a treatment, in this case consisting of a plurality of partial treatments, namely a plurality of milling treatments, performed on said larger panel or board 23. Only thereafter the respective board 23 or the larger panel is divided into the respective walls 3-4-5 by means of a dividing device 71, such as a sawing device with one or more rotating saw blades 72.

FIG. 23 represents the obtained walls 3-4-5. FIG. 24 represents that, for example, the sidewalls 3-5, can also be post-treated for realizing connection means 9 other than locking profiles, or a portion of such connection means 9 17. In the example, to this aim also bore holes 17 are performed for providing dowels or other connection elements 15 therein. FIG. 25 represents that, for example, the rear wall 3 can be provided with an edge finish, for example, such as here in the form of a masking tape 73 or ABS strip.

FIG. 26 represents the assembly or the drawer 1 which can be obtained on the basis of the respective sidewalls 4-5 and rear wall 3. To this aim, additionally a front panel or front wall 2 is attached to the narrow side ends 19 of the sidewalls 4-5, by means of said dowels, and a drawer bottom 6 is inserted in grooves 21 provided to this aim in said walls 2-3-4-5. Such grooves 21 can be provided in the walls 2-3-4-5 in a similar manner as illustrated in FIG. 20. Such treatment station 49 is not represented here, however, can be arranged downstream in the device of FIG. 20 in the same manner as illustrated in FIG. 12.

It is clear that any locking profiles can be applied, which preferably are laterally insertable. So, for example, possibly the gap 14 can be omitted in the tongues 10.

FIGS. 27 and 28 represent that according to a preferred embodiment of the method of the invention the profile of a tongue 10A, instead of on the short sides of the larger panel or the board 23, can also be formed centrally in said board 23. Preferably, this is realized, such as here, at the location of a final, obtained after dividing the board 23, narrow-side or distal end 19 of a wall 4-5. It is clear that in the examples of FIGS. 27 and 28 the tongues 10A are intended for being provided in a groove 11A. To this aim, the grooves 10A have an almost complementary shape, however, possible free intermediate spaces not taken into account. When fitting together the tongue 10A and the groove 11A, for example, by means of a turning movement, a locking tongue-in-groove connection of respectively a sidewall 4-5 and a rear wall or a front wall 3 can be obtained.

The particularity of the profile of the tongues 10A represented in the example also is that the side 74 of the tongue 10A opposite to the side of the locking part 12A, which side 74 in the figure is directed downward, is formed by the surface 75 of the larger panel or the board 23, or that this side 74, in other words, remains untreated. In this manner, it is obtained that the tongue 10A is free from parts, which, seen in the direction of the surface 75, extend beyond the edge 76 of this surface 75. In the case that this surface 75, such as here, is provided with a decorative layer 67, this layer preferably extends uninterruptedly up to the edge 76.

It is evident that the tongues 10, which in the example are formed on the short sides of the larger panel or the board 23, possibly may show a profile similar or identical to that of the tongues 10A.

FIGS. 29 and 30 represent that such tongue 10A substantially can be obtained by means of cutting treatments which engage on only one flat side 77 of said board 23. In this case, at least the locking parts 12A of the tongue 10A are obtained by means of such cutting treatments.

FIG. 29 as well as FIG. 30 also illustrate the particular embodiment mentioned in the introduction, wherein at least a partial treatment, in this case the partial treatment of FIG. 29, wherein a cutting tool 69A is simultaneously active on two walls, in this case on the sidewall 4 as well as on the rear wall 3. The cutting tool 69A engages on the flat side 77 of the board 23 and hereby simultaneously forms parts of a groove 11A and a tongue 10A. In this case, this relates to portions of a tongue 10A, which fits into the respective groove 11A, however, this is not necessarily the case. Preferably, by means of such cutting treatment at least the locking parts 12A-13A either of the tongue 10A or of the groove 11A or of both are formed. In the example, the locking part 12A of the tongue 10A is formed and simultaneously a part of the profile 25 of the groove 11A. In the example, a rotating cutting tool 69A is applied. The respective cutting tool is arranged inclined and hereby forms an angle B1 of approximately 50° with the normal N of the flat side 77.

FIG. 30 represents how the remaining part of the profile 25 of the groove 10A can be formed with a second cutting tool 69B. To this aim, a rotting cutting tool 69B is applied. The rotating cutting tool 69B is arranged inclined and hereby forms an angle B2 of approximately 50° with the normal N of the flat side 77.

FIGS. 29 and 30 as such illustrate an embodiment of the invention, wherein exactly two cutting tools 69A-69B are applied for forming the essential part of the groove 11A as well as of the tongue 10A. Preferably, both cutting tools are arranged inclined. Preferably, they both form an angle B1-B2 with the normal N on the surface 77, situated between 5° and 60°, or still better between 40° and 60°. Preferably, these angles are equal or approximately equal for both tools, for example, with a difference of less than 10°, or even less than 5° or less than 2°.

FIG. 31 represents that the dividing of the board 23 also realizes the final part of the profile of the tongue 10A. Preferably, by means of such two cutting tools, such as here, at least the locking parts 12A and 13A of the tongue 10A as well as of the groove 11A are formed, as well as preferably the entire or approximately the entire groove profile 25.

It is clear that the walls 3-4-5, together with a front panel 2 and a bottom 6, can be composed to a drawer 1. Hereby, an example is obtained according to the sixth example mentioned in the introduction. FIG. 32 represents how the rear wall 3 can be connected to a sidewall 4 by means of the mutually cooperating locking profiles of the tongue 10A, on the one hand, and the groove 11A, on the other hand.

FIG. 33 represents another variant of a tongue 10A, wherein also on the surface 75 of the board 23 a treatment is performed by means of a cutting tool 78, such that the tongue 10A, in this case, indeed has portions extending beyond the edge 76 of the surface 75. The inventor has found that such treatment can result in a better precision. Preferably, the groove profile 25 of the groove 11A, as represented here, is correspondingly adapted as well. Preferably, such treatment is performed prior to dividing the board 23 into the walls 3-4-5 concerned.

As aforementioned, it is clear that the invention primarily is intended for wood-based drawers.

The present invention is in no way limited to the embodiments described by way of example and represented in the figures; on the contrary, such drawers and methods for manufacturing drawers can be realized according to various variants, without leaving the scope of the invention.

1-14. (canceled)

15. A method for manufacturing drawers, wherein the drawers comprise walls and a bottom, wherein said walls comprise at least a front wall, rear wall and two sidewalls, and wherein at least a first and a second of said walls comprise profiles which fit into each other in a locking manner and which make use of a tongue and a groove with locking parts, wherein said profiles can be joined into each other laterally, and wherein the respective groove is provided on the inner side of the first wall, whereas the respective tongue is provided on the distal end of the second wall; wherein two or more walls are manufactured of one board; wherein the profiles of the respective walls are formed by means of a treatment, whether or not consisting of a plurality of partial treatments, performed on said board; and wherein said board is divided into two or more walls only after at least parts of said profiles have been formed.

16. The method of claim 15, wherein said treatment is a continuous treatment.

17. The method of claim 15, wherein at least said first wall and second wall are formed from said one board.

18. The method of claim 15, wherein said profiles comprise at least a tongue, formed on a distal end of said board.

19. The method of claim 15, wherein said profiles comprise at least a groove, formed in a flat side of said board.

20. The method of claim 15, wherein three walls are obtained from said board, including two sidewalls and a front wall or a rear wall.

21. The method of claim 15, wherein all locking profiles of the respective walls are formed at least partially or even entirely prior to dividing said board into the respective walls.

22. The method of claim 15, wherein after the dividing of the respective board still one or more treatments are performed on one or more of the obtained walls.

23. The method of claim 22, wherein after dividing, one or more treatments are performed for realizing connection means other than locking profiles.

24. The method of claim 22, wherein after dividing, one or more bore operations are performed for providing dowels or other attachment elements.

25. The method of claim 22, wherein after dividing, one or more masking operations are performed by means of a laminate strip or an ABS strip.

26. The method of claim 15, wherein the board, in a device provided for this purpose, is transported by means of a continuous system, from an input, along at least one treatment station, to an output, wherein the groove profile is drawn in the treatment station by means of at least one milling cutter.

27. The method of claim 15, wherein said treatment includes at least a partial treatment, wherein a cutting tool is simultaneously active on both walls.

28. A device for realizing the method of claim 15, which consists of a continuous system and various treatment stations erected there along, for performing one or more of the treatments described in the preceding claims.
